(19) United States
(12) Patent Application Publication
(10) Pub. No.: US 2005/0114891 A1
(43) Pub. Date: May 26, 2005

(54) Method of controlling a TV apparatus

(76) Inventor: Reidar Wasenius, Esbo (FI)

Correspondence Address: CRAWFORD MAUNU PLLC, 1270 NORTHLAND DRIVE, SUITE 390, ST. PAUL, MN, 55120, US

(21) Appl. No.: 10/718,132

(22) Filed: Nov. 20, 2003

(51) Int. Cl. H04N 7/16; H04N 7/00; H04N 11/00

(52) U.S. Cl. 725/62; 348/468; 725/136

(57) ABSTRACT

The present invention relates to a system comprising a TV apparatus (3) which is responsive to control signals transmitted to said TV apparatus via a wireless connection (7), a mobile station (2) of a user, and a network element (1) which is configured to receive and store user specific parameters regarding at least one television program. The network element is arranged to generate at least one control message and to transmit said at least one control message via a cellular radio system (9) to said mobile station (2) of said user. Said mobile station (2) is configured to transmit control signals generated from information included in said at least one control message to said TV apparatus (3) via said wireless connection (7) in order to control said TV apparatus (3) to customize said broadcasted television program according to the user specific parameters.

### BACKGROUND OF THE INVENTION

1. Field of the Invention

This invention relates to a solution for controlling a TV apparatus in such a way that a broadcasted program is presented for a user in a way which, as far as possible, takes into account the interests and wishes of the user. The present invention more particularly relates to an interactive system where the user can by participating affect the way a broadcasted program is presented for the user.

In this application the term TV apparatus should be understood broadly to include any equipment which can be used to receive television broadcasts, such as televisions, set-top boxes and recorders.

2. Description of the Prior Art

A problem with the existing television systems is the incapability to take into account the desires and wishes of a single user (viewer). The broadcasted programs are presented in the same way to all users. If the user has a special interest in a television program and the user wants to find out more information about a specific topic relating to the program, then the user must find this information by himself, for instance, by searching through available text TV pages, magazines or Internet pages. In some cases specific text TV pages can be announced during the broadcasted program. However, it is up to the user to control the used TV apparatus to show these text TV pages.

### SUMMARY OF THE INVENTION

An object of the present invention is to solve the above-mentioned drawback and to provide a solution for controlling a TV apparatus such that the interests and desires of the user can be taken into account more efficiently than in prior art solutions.

Another object of the present invention is to provide a more user-friendly solution which makes it easier for a user to find program-related information which he might be interested in.

Still another object of the present invention is to achieve an interactive solution for presenting broadcasted programs to a user such that the user is given an opportunity to interact with the broadcasted program before, during or after the broadcasting of the program in question.

These and other objects of the present invention are achieved with the method according to independent claim 1, the system according to independent claim 5, the network element according to independent claim 7, the mobile station according to independent claim 14 and the program according to independent claim 16.

The present invention offers the user the possibility of signing user specific parameters regarding at least one television program in a network element. When the television program in question is broadcasted, then the network element retrieves the stored user specific parameters and utilizes them for generating and transmitting control messages to the user's mobile station. The user's mobile station generates control signals based on the received control messages and transmits these control signals to the TV apparatus being used by the user.

The invention makes it possible to control the TV apparatus in such a way that the interests and desires of the user, as defined in the user specific parameters, are taken into account. It is not necessary for the user to take any manual actions in order to find information which interests the user, as the TV apparatus can automatically be controlled to present such information to the user. It is also possible for the user to interact with the broadcasted program, because the communication path between the network element, the mobile station of the user, and the TV apparatus of the user can be used for transfer of information between the network element and the user before, during or after the broadcasting of the program in question.

In this application the term mobile station should be understood broadly to include any portable communication apparatus which can be used for communication via a cellular radio system. The mobile station can thus be, for instance, a mobile phone, a personal communicator, an entertainment terminal or a personal digital assistant (PDA).

In a preferred embodiment of the invention the network element is responsive to predetermined events that occur during the program. When such a predetermined event occurs, the network element can search through the content of its memory in order to identify the mobile stations of those users whose user specific parameters indicate that these users are specially interested in this event. A control message can therefore be transmitted to the mobile stations of these users when the event occurs in the program. In this way, the TV apparatuses of the users in question can be controlled to take specific actions in order to provide these users with, for instance, additional information about the event in question.

The preferred embodiments of the method, system, network element and mobile station of the invention are disclosed in dependent claims 2 to 4, 6, 8 to 13 and 15.

### BRIEF DESCRIPTION OF THE DRAWINGS

In the following, the present invention will be described in closer detail by way of example and with reference to the attached drawings, in which

FIG. 1 is a flow diagram illustrating a first preferred embodiment of the present invention, and

FIG. 2 is a block diagram illustrating a first preferred embodiment of the present invention.

### DESCRIPTION OF THE PREFERRED EMBODIMENTS

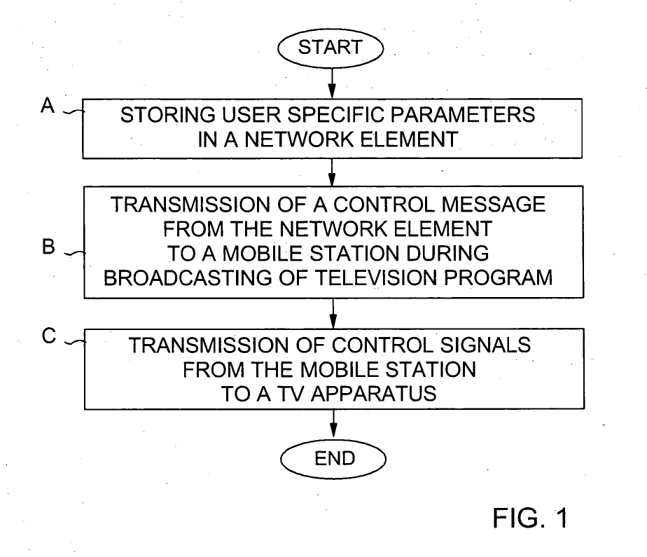

FIG. 1 is a flow diagram illustrating a first preferred embodiment of the present invention.

In block A the user specific parameters are stored in a network element, which may be a server operated by a television station. The user specific parameters can be stored by the user by using his mobile station. The user specific parameters indicate how the user wants a specific television program to be presented to him. For instance in the case of a talk show, the parameters may indicate that the user wants to obtain information about each person participating in the talk show as soon as this person enters the program. The user specific parameters also include information identifying the mobile station of the user. This makes it possible for the network element to transmit messages to the user. The information identifying the mobile station may be, for instance, its MSISDN (Mobile Subscriber International ISDN Number) number or the IP address of the mobile station in question.

When the broadcasting of a program begins, the network element searches through its memory to identify user specific parameters associated with this program. At this stage the network element detects that a user has requested information about persons entering the program. The network element is in this example assumed to be responsive to predetermined events that occur in the television program, such as the event when a new person enters the program. When this occurs, the network element generates and transmits a predetermined control message via a cellular radio system to the mobile station in block B. The control message is received by the mobile station of the user.

In block C the mobile station utilizes the received control message to generate control signals, which are transmitted to the TV apparatus of the user. The control message from the network element may have been selected in such a way that it controls the mobile station to transmit control signals, which control the TV apparatus of the user to display a predetermined text TV page where information is available about the new person who has entered the broadcasted talk show. The text TV page can be displayed as such, which means that it hides the TV picture, or alternatively as overlaid, in which case the text of the text TV page is displayed on the picture, which makes it possible to read the text of the text TV page while watching the talk show.

The user will thus be presented with the additional information automatically without any manual actions by the user during the program. After a while, when a predetermined time has passed since the control message from the network element, the network element may transmit a new control message to the mobile station of the user. This second message may control the mobile station to transmit control signals to the TV apparatus, which removes the text TV page and instead returns the broadcasted talk show to the screen of the TV apparatus.

As an alternative to providing additional information for the user by displaying a text TV page, it is naturally also possible to control the TV apparatus to make some other changes, for instance to display the clock, adjust the sound level or to switch to another channel with additional information for a while. It is also possible that the TV apparatus includes a recorder, such as a video recorder or a DVD recorder, and that the user specific parameters indicate that the user wants to record a television program or parts of a television program. In that case such a control message is selected by the network element, which will control the mobile station to transmit control signals that control the TV apparatus to record the broadcasted program. The present invention also offers the opportunity for automatic turning on and off the TV apparatus according to the wishes of the user. This is useful especially in mornings and evenings if the user wants to wake up to a specific broadcast or to ensure that the TV apparatus is turned off automatically after a certain program. It is even .possible that the TV apparatus could be turned on if there is an especially urgent broadcast that calls for the attention of the user, which even has security implications.

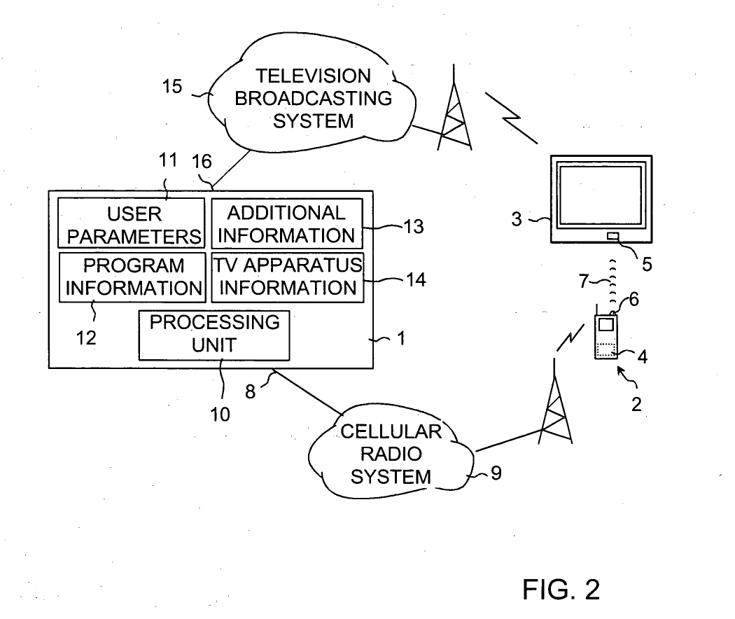

FIG. 2 is a block diagram illustrating a first preferred embodiment of the present invention. The system shown in FIG. 2 includes a network element 1, which may be a server operated by a television station. The user has available a mobile station 2 and a TV apparatus 3. The mobile station includes a processing unit and a memory, which are indicated by reference numeral 4. In order to carry out the present invention, client software has been installed in the mobile station 2.

The mobile station 2 may communicate with the TV apparatus 3 by IR (Infrared light) signals. For this purpose the TV apparatus 5 is equipped with an IR receiver 5, and the mobile station is equipped with an IR transmitter 6. Thus the mobile station can transmit controls signals 7 to the TV apparatus in the same manner as a prior art remote control does.

The use of IR signals is advantageous as many TV apparatuses and mobile stations already have the necessary equipment installed. Thus it is sufficient to install a suitable client software in the mobile station to carry out the invention. However, it is also possible to utilize, for instance, a short range radio system, such as Blue-tooth, in order to control the TV apparatus with the mobile station. This naturally requires that the mobile station and the TV apparatus have the necessary equipment.

The network element 1 has an interface 8 to a cellular radio system 9 for providing a communication path between the mobile station 2 and the network element 3. The network element further has a processing unit 10 and a memory 11 for storing user parameters, a memory 12 for program information, a memory 13 for additional information and a memory 14 for TV apparatus information. These memories may be implemented as one or several memories or storage media containing all the above-mentioned information. The network element 1 also has an interface 16 to a television broadcasting system 15. Thus the network element can receive information about when predetermined events occur in a broadcasted television program.

The system of FIG. 2 functions as follows:

When the user of a mobile station 2 decides to interact with the network element 1, the user activates the software client with the user interface of the mobile station 2, for instance by pressing predetermined buttons on the keypad of the user interface. Initially the user might want to obtain television program information. Thus a request for television program information is transmitted from the mobile station 4 to the network element 1. The network element retrieves the information from memory 12 and transmits it to the mobile station. Thus the user can select a program of interest.

The received program information for the selected program can include questions to the user, for instance in case of a hockey game, the user can be given the opportunity to select which team is his favorite and which player is his favorite. When the user answers these questions, the answers are transmitted to the network element 1, which stores them as the user parameters for the program and user in question in memory 11.

Once the user parameters are known to the network element 1, the network element can retrieve additional information for the program in question from memory 13 and send it to the user with one or more additional messages. The additional information may include information relating to betting, voting, a quiz or a lottery. When the selected program is a hockey game, the additional information may be an offer to the user to place a bet on the outcome of the game. The user can place the bet with his mobile station 2, and the bet is registered by the network element.

When the television broadcasting system 15 starts to broadcast the program selected by the user, then the network element 1 will receive information about this via an interface 16. In case the user parameters in memory 11 indicate that the user has requested a reminder when the program begins, then a reminder is transmitted from the network element 1 to the mobile station 2. Thus the user receives the information that he should turn on his TV apparatus and place his mobile station 2 within range of the TV apparatus 3.

At present many TV apparatus manufacturers have in use remote control systems which are not compatible with each other. In order to ensure that the mobile station 2 of the user can cooperate with the TV apparatus 3 used by the user at that particular moment, it might be necessary to download information defining the control signals used by the TV apparatus model in question to the mobile station. For this purpose the network element 1 has available a memory 14 with a list of existing TV apparatus models and information defining the control signals used for controlling them. Thus the user can transmit a request containing information which identifies the used TV apparatus to the network element with the mobile station 2. As a response the network element 1 will transmit the information defining the control signals for the TV apparatus in question. After this the mobile station will be able to act as a remote control for the TV apparatus.

As an alternative to the above described, it is also possible that the mobile station itself includes a list of existing TV apparatuses and their control signals in a memory. Such a list may be installed in the mobile station as part of the client software, which makes it possible to utilize the mobile station for the present invention. In this case the network element does not need the memory 14 with TV apparatus information.

When the broadcasting of the program has begun and a predetermined event occurs, for instance a goal in a hockey game, the network element will receive information about the event from the television broadcasting system 15. If the user parameters of the user, for instance, indicate that the user immediately wants additional information about the person who made the goal, then a control message is transmitted from the network element 1 to the mobile station. The processing unit of the mobile station processes the control message in order to generate an appropriate control signal 7 to be transmitted to the TV apparatus. If, for instance, the television broadcasting system transmits additional information about the person who scored the goal on text TV page 303, then the control signals 7 will command the TV apparatus to show text TV page 303. After a while, the network element will transmit a new control message to the mobile station, or the software client in the mobile station will automatically send new control signals to the TV apparatus in order to remove the text TV page such that only the broadcasted program is again visible on the TV screen.

In addition to transmitting control messages, which will cause the mobile station to control the TV apparatus, the network element 1 can also transmit additional messages to the mobile station during the broadcasted program. Such other messages may include additional information for the user which is displayed on the display of the mobile station. Alternatively such additional messages may offer the user the possibility of, for instance, placing bets, participating in a quiz, individually selecting or to collectively voting about something which relates to the ongoing program. Such additional messages can be transmitted by the network element 1 when predetermined events occur in the broadcasted program, or alternatively at predefined moments. The additional information in memory 13 might for instance include a special offer with a discount for tickets to a hockey game, which is transmitted on a specific day and at a specific time to all those users whose user parameters indicate that the favorite team of the users is one of the teams that will play in the game in question.

When the program has ended, the user can be given the opportunity to give ratings, feedback, buy merchandise or to participate in a chat with other viewers of the program by using his mobile station. The network element 1 can also transmit, for instance, voting or betting results to the mobile station 2 after the program has ended.

An advantage obtained with the present invention is that the user can utilize practically any available TV apparatus located in a private or public space, such as in a private home of someone else, a hotel room, a public bar or an airport lobby, and by using his own mobile station ensure that a program he has selected will be presented to him by taking into account his personal whishes and interests. Any costs involved in utilizing the system will be directed to the mobile station of the user. Such costs can include telecommunication costs, costs defined by the operator of the network element for using the available services and costs caused by the user, for instance, by participating in betting.

It is to be understood that the above description and the accompanying Figures are only intended to illustrate the present invention. It will be obvious to those skilled in the art that the invention can be varied and modified also in other ways without departing from the scope and spirit of the invention disclosed in the attached claims.

1. A method of controlling a TV apparatus, said method comprising:
storing user specific parameters regarding at least one television program in a network element, said user specific parameters including information identifying a mobile station of said user,
transmitting at least one control message from said network element via a cellular radio system to said mobile station when said at least one television program is being broadcasted, and
transmitting control signals generated from information included in said at least one control message from said mobile station to said TV apparatus in order to control said TV apparatus to customize said broadcasted television program according to the user specific parameters.

2. The method according to claim 1, wherein said network element is configured to transmit control messages to said mobile station when predetermined events occur in said broadcasted television program.

3. The method according to claim 1, wherein said TV apparatus is controlled to display predetermined text TV pages, as such or overlaid.

4. The method according to claim 1, comprising:
transmitting additional information relating to the program, questions relating to the program or an invitation to participate in betting, lottery, vote or a quiz from said network element to said mobile station before, after or during the broadcasting of said television program.

5. A system comprising:
a TV apparatus which is responsive to control signals transmitted to said TV apparatus via a wireless connection,
a mobile station of a user, and
a network element which is configured to receive and store user specific parameters regarding at least one television program, said user specific parameters including information identifying the mobile station of said user, and to utilize said user specific parameters in order to generate at least one control message and to transmit said at least one control message via a cellular radio system to said mobile station of said user, when said at least one television program is broadcasted, and
said mobile station is configured to transmit control signals generated from information included in said at least one control message to said TV apparatus via said wireless connection in order to control said TV apparatus to customize said broadcasted television program according to the user specific parameters.

6. The system according to claim 5, wherein said network element is configured to transmit predetermined control messages to said mobile station in response to predetermined events which occur in said television program, said predetermined control messages being selected in order to control the mobile station to transmit control signals to the TV apparatus for controlling said TV apparatus to display predetermined text TV pages, as such or overlaid, when said events occur in the program.

7. A network element comprising:
an interface to a cellular radio system for communicating with mobile stations of said system,
a memory for storing user specific parameters regarding at least one television program, said user specific parameters including information identifying a mobile station of said user, and
a processing unit which is configured to, when said at least one television program is broadcasted, retrieve said user specific parameters from said memory, to utilize said user specific parameters in order to generate at least one control message for controlling said mobile station of said user to transmit predetermined TV apparatus control signals, and to transmit said at least one control message via said interface and said cellular radio system to said mobile station of said user.

8. The network element of claim 7, wherein
said network element further comprises an interface to a television broadcasting system for receiving signals indicating the moments when predetermined events occur in the broadcasted television program, and
said processing unit is responsive to said signals and to said user specific parameters for generating and transmitting control messages via said interface and said cellular radio system.

9. The network element of claim 7, wherein
said network element further comprises a memory for storing additional information relating to said at least one television program, and
said processing unit is configured to retrieve said user specific parameters from said memory, to select additional information from said memory based on said user specific parameters, to generate an additional message containing the selected additional information, and to transmit said additional message via said interface and said cellular radio system to said mobile station of said user before, during or after the broadcasting of said television program.

10. The network element of claim 8, wherein said memory for storing additional information contains additional information relating to betting, voting, a quiz or a lottery.

11. The network element of claim 7, wherein
said network element further comprises a memory for storing program information, and
said processing unit is configured to retrieve program information from said memory and to transmit said retrieved program information via said cellular radio system to a mobile station as a response to a request for program information received from said mobile station.

12. The network element of claim 7, wherein said processing unit is configured to receive, via said cellular radio system, from a mobile station information including user specific parameters for a television program, and to store the received user specific parameters including information identifying the mobile station in said memory.

13. The network element of claim 7, wherein
said network element further comprises a memory containing a list of different TV apparatus models and for each TV apparatus model information defining the control signals for controlling the respective TV apparatus model, and
said processing unit is configured to retrieve the information defining the control signals from said memory for controlling a specific TV apparatus model and to transmit this information via the cellular radio system to a mobile station, as a response to a request from said mobile station.

14. A mobile station of a cellular radio system comprising:
a receiver for receiving a control message from a network element via a cellular radio system,
a processing unit for processing said received control message in order to generate control signals from information included in said control message, and
a transmitter for transmitting said generated control signals via a wireless connection to a TV apparatus.

15. The mobile station of claim 14, further comprising:
a memory containing a list of different TV apparatus models and for each TV apparatus model, information defining the control signals for controlling the respective TV apparatus model, and
a user interface for providing a user of said mobile station with an opportunity to select a TV apparatus model from said list,
said processing unit being configured to retrieve the information corresponding to the TV apparatus model selected by the user from said memory, and to use the retrieved information in said generating of said control signals.

16. A program for controlling a programmable apparatus to:
receive a control message from a cellular radio system,
process said received control message in order to generate control signals from information included in said control message, and
transmit said control signals via a wireless connection to a TV apparatus.
